(19) United States
(12) Patent Application Publication
(10) Pub. No.: US 2006/0069741 A1
(43) Pub. Date: Mar. 30, 2006

(54) Route objects in telecommunications networks

(76) Inventor: Stephen Brian Morris, Dublin (IE)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/536,650

(22) PCT Filed: Nov. 20, 2003
(86) PCT No.: PCT/IB03/06377

§ 371 Date: May 26, 2005

(30) Foreign Application Priority Data
Nov. 29, 2002 (GB) 0227797.8

(51) Int. Cl. G06F 15/16

(52) U.S. Cl. 709/217; 709/224

(57) ABSTRACT

In a telecommunications network, a route object (RO) computer program product, creates a RO which presents a user with editable fields relating to more than one type of RO, and allows the user to specify the contents of one or more of the fields to create any one of the types of RO. The editable fields may relate to a protocol used by the RO, or a type of route defined by a RO, or at least one network element (NE) of a route defined by the RO, or at least one hop of the RO. The RO computer program product may interface with the user, for example a GUI which presents one or more windows to the user to allow the user to create a RO. For example, a NE listing window may be presented to the user, which comprises a NE context menu having a create RO menu item which brings up a window comprising a RO creation dialog box, which comprises one or more editable fields relating to more than one type of RO and the user specifies the contents of one or more of the fields to create any one of the types of RO.

This invention relates to route objects (ROs) in telecommunications networks, and particularly to the creation of ROs and subsequent connections in a network.

Networks elements (NEs) in a telecommunications network are physically linked together by, for example, cables. In addition, logical links, or connections, are set up between elements allowing traffic to be passed from one element to another. The route that a connection follows through the network can be defined in a route object (RO). In any particular network, many different routes using one or more signalling protocols may be used. This results in many different types of ROs. Currently, RO creation is a manual process, requiring detailed knowledge of the route of the RO, and the process changes according to the type of RO being created. This can be difficult and time-consuming for a user of the network.

According to a first aspect of the invention, in a telecommunications network, there is provided a route object computer program product, comprising means for creating a route object (RO) which presents a user with editable fields relating to more than one type of RO, and allows the user to specify the contents of one or more of the fields to create any one of the types of RO.

The RO computer program product provides a generic means for creating a RO, i.e. a means that can be used regardless of the type of RO to be created. This simplifies the user's role in RO creation.

Each type of RO may comprise a definition of a route through the telecommunications network. Each type of RO may comprise one or more hops, i.e. a definition of a route from a network element (NE) to an adjacent NE in the telecommunications network. The route of a RO may be used to set up a connection in the telecommunications network.

The RO computer program product may present one or more editable fields relating to an identifier of a RO, for example a user-defined name of a RO.

The RO computer program product may present one or more editable fields relating to a type of route defined by a RO. This may determine the type of connection which can be set up using the RO. The type of route may comprise a multi protocol label switching (MPLS) signalled route, e.g. a MPLS signalled permanent label switched path (SP-LSP). The RO computer program product may present one or more editable fields relating to a RO defining a MPLS SP-LSP. This may be known as a Fore Thought (RTM) explicit route object (FTERO). The type of route may comprise a MPLS unsignalled route, e.g. a MPLS permanent label switched path (P-LSP). The RO computer program product may present one or more editable fields relating to a RO defining a MPLS P-LSP. The type of route may comprise an asynchronous transfer mode (ATM) signalled route, e.g. an ATM signalled permanent virtual circuit (SPVC). This may be known as a designated transit link (DTL) RO.

The RO computer program product may present one or more editable fields relating to at least one NE of a route through the telecommunications network defined by a RO. The NE may be a start NE where a route defined by the RO originates. The NE may be an end NE where a route defined by the RO terminates. The NE may be an intermediate NE between a start NE and an end NE. The one or more editable fields relating to a NE may relate to an identifier of the NE, for example a user-defined name of the NE, and/or an Internet Protocol (IP) address of the NE. The one or more editable fields relating to a NE may relate to details of an ingress interface of the NE. The one or more editable fields relating to a NE may relate to details of an egress interface of the NE. The details of the ingress interface and/or the egress interface may comprise an IP address of the interface, and/or a virtual path identifier (VPI) of the interface, and/or a virtual channel identifier (VCI) of the interface, and/or an identifier, e.g. a user-defined name, of the interface, and/or a MPLS label of a P-LSP arriving at the interface.

The RO computer program product may present one or more editable fields relating to a designated transit link (DTL) backoff value of a RO.

The RO computer program product may present one or more editable fields relating to at least one hop of a RO. The one or more editable fields relating to a hop may relate to an identifier of the RO comprising the hop, for example a user-defined name of the RO comprising the hop. The one or more editable fields relating to a hop may relate to an index of the hop, i.e. the position of the hop within the RO comprising the hop. The one or more editable fields relating to a hop may relate to an identifier, e.g. a user-defined name, of a start NE, which is the NE where a route defined by the hop starts. The one or more editable fields relating to a hop may relate to an identifier, e.g. a user-defined name, of an end NE, which is the NE that the route defined by the hop terminates. The one or more editable fields relating to a hop may relate to a type of route defined by the RO comprising the hop. The one or more editable fields relating to a hop may relate to the general position of the hop within the RO comprising it, e.g. an originating hop, or a passing through hop, or a terminating hop. The one or more editable fields relating to a hop may relate to one or more protocols used by the hop, e.g. ATM or MPLS or a combination of these. The one or more editable fields relating to a hop may relate to an ingress interface of the start NE, i.e. the NE where the route defined by the hop starts. The one or more editable fields relating to a hop may relate to an ingress IP address of the ingress interface. The one or more editable fields relating to a hop may relate to an ingress VPI of the ingress interface. The one or more editable fields relating to a hop may relate to an ingress VCI of the ingress interface. The one or more editable fields relating to a hop may relate to an identifier, e.g. a user-defined name, of the ingress interface. The one or more editable fields relating to a hop may relate to an ingress MPLS label of a P-LSP arriving at the ingress interface. The one or more editable fields relating to a hop may relate to an egress interface of the start NE. The one or more editable fields relating to a hop may relate to an egress IP address of the egress interface. The one or more editable fields relating to a hop may relate to an egress VPI of the egress interface. The one or more editable fields relating to a hop may relate to an egress VCI of the egress interface. The one or more editable fields relating to a hop may relate to an identifier, e.g. a user-defined name, of the egress interface. The one or more editable fields relating to a hop may relate to an egress MPLS label of a P-LSP arriving at the egress interface.

The RO computer program product may present the user with the editable fields relating to the types of RO all at the same time, or in groups of editable fields, or one editable field at a time. The user may specify the contents of a first subset of the editable fields to create a first type of RO, or may specify the contents of a second subset of the editable fields to create a second type of RO, etc., for each of the types of RO. For example, with regard to the one or more editable fields relating to an ingress or egress interface of a RO hop, the user may specify the contents of one or more fields relating to the ingress interface and the egress interface to create, for example, a RO defining a MPLS P-LSP, or may specify the contents of one or more fields relating to the ingress interface only to create, for example, a RO defining a MPLS SP-LSP, or may specify the contents of one or more fields relating to the egress interface only to create, for example, a RO defining a ATM SPVC.

The or each or some of the editable fields presented to the user by the RO computer program product may be empty. The user may specify the contents of one or more of the editable fields by writing into them to create any one of the types of RO. The or each or some of the editable fields presented to the user by the RO computer program product may contain one or more default settings. The user may specify the contents of one or more of the editable fields by editing the or each default setting to create any one of the types of RO. For example, the or each or some of the editable fields may contain a drop-down list of default settings, and the user may choose from the settings to create any one of the types of RO.

When the user specifies the contents of one or more editable fields, the field or fields specified and/or the contents specified may be used by the RO computer program product to determine which subsequent editable field or fields presented to the user. When the user specifies the contents of one or more editable fields, the field or fields specified and/or the contents specified may be used by the RO computer program product to determine one or more default settings of one or more subsequent editable fields presented to the user. For example, when the user specifies the contents of one or more editable fields relating to a start NE and an end NE in a route defined by a RO, the RO computer program product may present the user with one or more editable fields containing default settings listing the possible intermediate NEs between the start NE and the end NE.

The RO computer program product may comprise means for modifying one or more ROs. The RO computer program product may comprise means for modifying one or more hops. This may allow a RO or hop to be edited to respecify the contents of one or more of the editable fields relating to the RO or the hop.

The RO computer program product may comprise means for copying one or more ROs. The RO computer program product may comprise means for copying one or more hops. Copying a RO or hop is especially useful when creating a RO or hop only slightly different from an existing RO or hop. The existing RO or hop can be copied and modified, which may be easier than creating a new RO or hop.

The RO computer program product may comprise means for storing one or more ROs in a storage facility, e.g. a database. The RO computer program product may comprise means for storing one or more hops in a storage facility, e.g. a database. Storing a RO or hop allows a user to define a RO or hop and save it for future use. This is useful if the RO is used to set up a network connection which gets torn down and recreated frequently. Only the connection is destroyed, the RO remains and can be used again.

The RO computer program product may comprise means for deleting one or more ROs. The RO computer program product may comprise means for deleting one or more hops.

The RO computer program product may comprise means for discovering one or more ROs. For example, ATM DTLs, and MPLS EROs may be stored in one or more NEs of the telecommunications network, and the RO computer program product may discover these using, for example, SNMP requests. The RO computer program product may store the discovered DTLs and EROs as ROs.

The RO computer program product may comprise means for discovering changes in the telecommunications network. The RO computer program product may comprise means for updating one or more ROs to accommodate changes in the telecommunications network.

The RO computer program product may comprise means for interfacing with the user. The means for interfacing may present the same interface to the user regardless of the type of RO to be created. The means for interfacing may comprise, for example, a graphical user interface (GUI). The GUI may present one or more windows to the user, to allow the user to create a RO. For example, the GUI may present a NE listing window to the user, which may list the NEs of the telecommunications network. The NE listing window may comprise a NE context menu. The NE context menu may comprise a create RO menu item. The create RO menu item may bring up a window comprising a RO creation dialog box. The RO creation dialog box may comprise one or more editable fields relating to more than one type of RO, and the user may specify the contents of one or more of the fields to create any one of the types of RO. The or each or some of the editable fields may be empty, and the user may specify their contents by writing into them. The or each or some of the editable fields may contain one or more default settings, and the user may specify their contents by editing the default settings. The RO creation dialog box may comprise a RO details grouping of editable fields. A RO being created may comprise one or more hops. A hop may be added to the RO using a window comprising a hop creation dialog box. The hop creation dialog box may comprise one or more editable fields relating to more than one type of hop, and the user may specify the contents of one or more of the fields to create any one of the types of hop. The or each or some of the editable fields may be empty, and the user may specify their contents by writing into them. The or each or some of the editable fields may contain one or more default settings, and the user may specify their contents by editing the default settings. The RO creation dialog box may bring up the hop creation dialog box. The RO creation dialog box may comprise a hop listing table, which may bring up the hop creation dialog box. The hop listing table may comprise one or more buttons, for example an add hop button. The add hop button may bring up the hop creation dialog box. The hop creation dialog box may comprise one or more buttons, for example a cancel button and/or an OK button. Selecting the cancel button may dismiss the hop creation dialog box without making any changes to its editable fields. Selecting the OK button may commit any changes to its editable fields to a created hop, dismiss the hop creation dialog box, and return the user to the RO creation dialog box. The created hop may be displayed in a row of the hop listing table of the RO creation dialog box. The row may comprise one or more columns, the or each of which may display the contents of an editable field specified to create the hop.

The GUI may be used by the user to view, and/or edit, and/or copy, and/or delete a RO. The GUI may present one or more windows to the user, to allow the user to view, and/or edit, and/or copy, and/or delete a RO. For example, the GUI may present a NE listing window to the user, which may list the NEs of the telecommunications network. The NE listing window may comprise a NE context menu. The NE context menu may comprise a view RO menu item. The view RO menu item may bring up a RO listing window. The RO listing window may display all ROs on a NE. The RO listing window may comprise a RO listing table, each row of which may display details of a RO. Each RO in the RO listing table may be editable, for example by one or more buttons provided on the table. Each RO in the RO listing table may provide a context menu, which may comprise a view RO menu item, and/or a copy RO menu item, and/or a delete RO menu item, and/or a create hop menu item. For each RO, the copy RO menu item may allow a copy of the RO to be made, which may then be modified. For each RO, the delete RO menu item may allow removal of the RO from the RO listing table. For each RO, the create hop menu item may bring up a window comprising a hop creation dialog box, to add a hop to the RO. For each RO, the view RO menu item may bring up a RO viewing window. The RO viewing window may display details of the RO. The RO viewing window may comprise a route details grouping, which may comprise fields which display the same details of the RO as those in the RO listing table. One or more of the fields may be editable. The RO viewing window may comprise a hop listing table, each row of which may display details of a hop comprised in the RO. Each hop of the hop listing table may be editable, for example via one or more buttons. For example, a delete button may delete all selected hops, and an add button may bring up a hop creation dialog box, to add a hop to the RO. Each hop in the hop listing table may provide a hop context menu, which may comprise a view hop menu item, and/or a copy hop menu item, and/or a delete hop menu item. The view hop menu item may bring up a hop viewing window. The hop viewing window may display details of the hop. The hop viewing window may comprise fields some of which are filled to display the same details of the hop as those in the hop listing table. The type of the hop will determine the fields which are filled. One or more of the fields may be editable.

The RO to be created may comprise a group RO i.e. comprise definitions of a group of routes between the same two NEs of the telecommunications network. This may be used for redundancy. At most one route within the group is active: when that route becomes inactive, another route within the group is made active. The network may automatically activate an alternative route should an active route fail. Routes can be grouped if the beginning and end points of all routes in the group are the same. The GUI may be used by the user to create a group RO. The GUI may present the same interface to the user regardless of the type of group RO to be created. The GUI may present one or more windows to the user, to allow the user to create a group RO. For example, the GUI may present a NE listing window to the user, which may list the NEs of the telecommunications network. The NE listing window may comprise a NE context menu. The NE context menu may comprise a create group RO menu item. The create group RO menu item may bring up a window comprising a group RO creation dialog box. The group RO creation dialog box may comprise one or more editable fields relating to more than one type of group RO, and the user may specify the contents of one or more of the fields to create any one of the types of group RO. The or each or some of the editable fields may be empty, and the user may specify their contents by writing into them. The or each or some of the editable fields may contain one or more default settings, and the user may specify their contents by editing the default settings. The group RO creation dialog box may comprise a route listing table. The route listing table may be editable, for example via one or more buttons. A route may be added to the table, and therefore the group RO, by selecting an add route button. The created route may be displayed in a row of the route listing table. The row may comprise one or more columns, which may display a user-defined name of the route, a user-defined name of a start NE where the route originates, a user-defined name of an end NE where the route terminates, the protocol that the route uses, and a route select checkbox. If the checkbox is ticked then the route is part of the group; if the box is cleared, then it is not. Double-clicking the box may toggle its state. The route listing table may be used to define each route's relative priority or weight within the group. Each route may be given a weight, with the route nearest the top of the list having the highest weight, and each route thereafter having a progressively lower weight.

The GUI may be used by the user to view, and/or edit, and/or copy, and/or delete a group RO. The GUI may present the same interface to the user regardless of the type of group RO to be viewed, edited, copied or deleted. The GUI may present one or more windows to the user, to allow the user to view, and/or edit, and/or copy, and/or delete a group RO. For example, the GUI may present a NE listing window to the user, which may list the NEs of the telecommunications network. The NE listing window may comprise a NE context menu. The NE context menu may comprise a view group RO menu item. The view group RO menu item may bring up a group RO listing window. The group RO listing window may display all group ROs on a NE. The group RO listing window may comprise a group RO listing table, each row of which may display details of a group RO. Each group RO may be editable, for example via one or more buttons provided on the table. Each group RO may provide a group RO context menu, which may comprise a view group RO menu item, and/or a copy group RO menu item, and/or a delete group RO menu item, and/or a create route menu item. For each group RO, the copy group RO menu item may allow a copy of the group RO to be made, which may then be modified. For each group RO, the delete group RO menu item may allow removal of the group RO from the group RO listing table. For each group RO, the create route menu item may bring up a window comprising a route creation dialog box. For each group RO, the view group RO menu item may bring up a group RO viewing window. The group RO viewing window may display details of the group RO. The group RO viewing window may comprise a group RO details grouping, which may comprise fields which display the same details of the group RO as those in the group RO listing table. One or more of the fields may be editable. The group RO viewing window may comprise a route listing table, each row of which may display details of a route comprised in the group RO. Each route of the route listing table may be editable, for example via one or more buttons. For example, a delete button may delete all selected routes, and an add button may bring up a route creation dialog box, to add a route to the group RO. Each route in the route listing window may provide a route context menu, which may comprise a view route menu item, and/or a copy route menu item, and/or a delete route menu item. The view route menu item may bring up a route viewing window. The route viewing window may display fields containing details of the route. One or more of the fields may be editable.

The RO computer program product may comprise part of a network management system (NMS) of the telecommunications network. The telecommunications network may comprise NEs each of which may comprise, for example, a node or a switch or a router.

According to a second aspect of the invention there is provided a method of creating a route object (RO), comprising: running the RO computer program product according to the first aspect of the invention which presents editable fields relating to more than one type of RO, and specifying the contents of one or more of the fields to create any one of the types of RO.

According to a third aspect of the invention there is provided a network management system (NMS) comprising: the RO computer program product according to the first aspect of the invention.

According to a fourth aspect of the invention there is provided a RO computer program product loadable into the memory of a computer system comprising: means for creating a route object (RO) which presents a user with editable fields relating to more than one type of RO, and allows the user to specify the contents of one or more of the fields to create any one of the types of RO.

According to a fifth aspect of the invention there is provided a RO computer program product stored on a computer usable medium comprising: computer readable program means for creating a route object (RO) which presents a user with editable fields relating to more than one type of RO, and allows the user to specify the contents of one or more of the fields to create any one of the types of RO.

According to a sixth aspect of the invention there is provided a computer system whose operation is directed by the RO computer program product according to the first aspect of the invention.

According to a seventh aspect of the invention there is provided a method of setting up a connection of a telecommunications network, comprising using a RO created using the RO computer program product according to the first aspect of the invention.

A RO may exist independently of any connection. A RO may be re-used in any number of connections. A RO is created once, and may be incorporated into many connections. When setting up a connection, the user may select an appropriate RO, or create a new RO, that logically connects required NEs of the telecommunications network. The RO computer program product may write the RO to a start NE of the route defined by the RO. One or more SNMP messages may be sent from the RO computer program product to the start NE containing all necessary protocol data units (PDUs) to completely define the RO. For signalled connections, it is not necessary to send SNMP requests to any of the other NEs in the route of the RO, therefore, the RO computer program product does not have to be concerned about partial successes due to some successful SNMP requests and some unsuccessful ones. A connection may then be created by the start NE initiating signalling (e.g. using RSVP protocol) to the next NE in the route, and so on to the end NE in the route. The end NE sends a reserve signal back through the NEs to the start NE, which reserves the bandwidth for the traffic, and thus a connection is created.

An embodiment of the RO computer program product of the first aspect of the invention will now be described by way of example only, with reference to the accompanying drawings, in which:

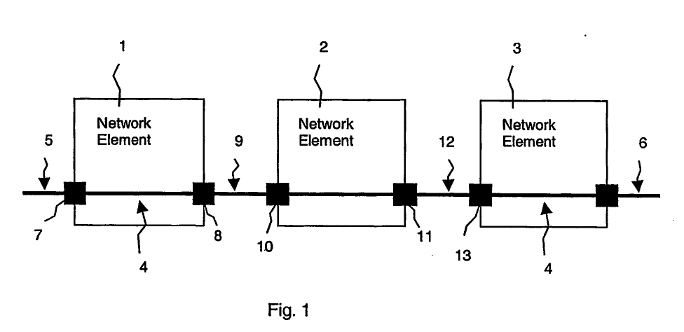

FIG. 1 is a schematic diagram showing a route through network elements of a telecommunications network, which route is defined by a RO created using the RO computer program product of the first aspect of the invention;

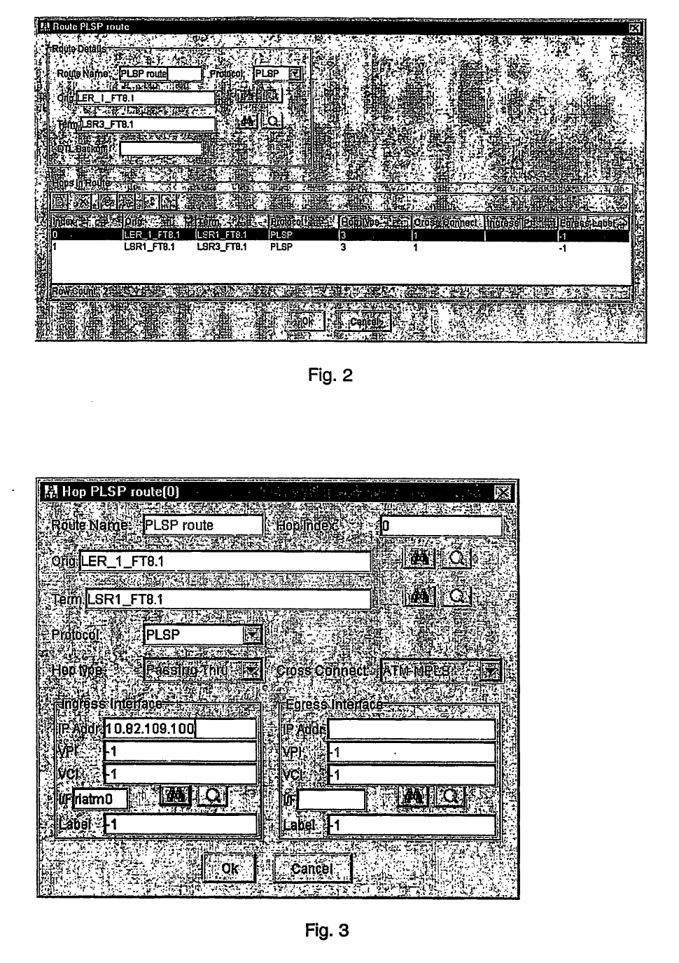

FIG. 2 is a RO creation dialog box used to create the RO defining the route of FIG. 1, and

FIG. 3 is a hop creation dialog box used to create the RO defining the route of FIG. 1.

FIG. 1 illustrates three network elements (NEs) 1, 2, 3 of a telecommunications network, and a route 4 through the NEs. The NEs are connected to a customer of the telecommunications network via a link 5 connected to the NE 1, which receives and transmits IP traffic to the customer over the link 5 using a protocol which will transfer this traffic (e.g. IP, ATM etc.). Similarly, the NEs are connected to another customer of the telecommunications network via a link 6 connected to the NE 3, which receives and transmits IP traffic to that customer over the link 6 using a protocol which will transfer this traffic (e.g. IP, ATM etc.). The route 4 through the NEs 1, 2, 3 comprises a MPLS P-LSP. This is defined by a RO, created using the RO computer program product, as follows.

The RO computer program product comprises a graphical user interface (GUI), which presents windows to a user, e.g. an operator of the telecommunications network, to allow the user to create the RO defining the route 4. The GUI presents a NE listing window to the user, which lists the NEs of the telecommunications network. The NE listing window comprises a NE context menu, which comprises a create RO menu item. On clicking the create RO menu item this brings up a window comprising a RO creation dialog box, as shown in FIG. 2. This comprises editable fields relating to more than one type of RO, the contents of which may be specified to create any one of the types of RO. In this embodiment, the creation of a RO which defines the route 4, comprising a MPLS P-LSP, is described. To create such a MPLS P-LSP RO the user first writes a user-defined name for the RO into the Route Name field, a user-defined name of the NE 1, where the route defined by the RO starts, into the Orig field, a user-defined name of the NE 3, where the route defined by the RO terminates, into the Term field, and the type of the route defined by the RO into the Protocol field of the RO creation dialog box. No DTL backoff value is written into the DTL Backoff field, as the RO being created defines the route 4, which comprises a MPLS P-LSP.

The route 4 comprises two hops, the first of which defines a route from the NE 1 to the NE 2, and the second of which defines a route from the NE 2 to the NE 3. The RO creation dialog box comprises a hop listing table, which is used to display the hops making up the RO being created. The hop listing table is editable via the buttons shown at the top of the table. To create a RO, the user adds one or more hops to the table, by selecting the add hop button. The add hop button brings up a window comprising a hop creation dialog box, as shown in FIG. 3. The route of the first hop starts at an ingress interface 7 of the NE 1, goes through the NE 1 to an egress interface 8 thereof, and along a link 9 to an ingress interface 10 of the NE 2, i.e. this hop starts at the NE 1 and goes to the NE 2. To define the route of this hop, it is necessary to provide information relating to the ingress interface 7 and the egress interface 8 of the NE 1. It is not necessary to provide information relating to the ingress interface 10 of the NE 2. This is because, once it is identified that the hop route should pass through egress interface 8 of the NE 1, this determines the remainder of the route as this interface is connected to link 9 which in turn is connected to ingress interface 10 of the NE 2. To create the first hop the user writes the name of the RO comprising the hop into the Route Name field, the position of the hop within the RO into the Hop Index field, a user-defined name of the NE 1, where the route defined by the hop starts, into the Orig field, a user-defined name of the NE 2, where the route defined by the hop goes to, into the Term field, the type of the route defined by the hop into the Protocol field, the general position of the hop within the RO into the Hop Type field, and the protocol(s) used by the hop into the Cross Connect field, of the hop creation dialog box. The user then writes the required information relating to the ingress interface 7 of the NE 1 into the ‘Ingress Interface’ fields of the hop creation dialog box. The route defined by the first hop will receive IP traffic and convert this into MPLS traffic, for passage along the route of the hop. Therefore, for this hop, the IP address of the ingress interface 7 is written into the IP Addr field, so that the IP traffic can be directed to this interface of the NE 1. No other information relating to the ingress interface 7 is required. The user then writes the required information relating to the egress interface 8 of the NE 1 into the ‘Egress Interface’ fields of the hop creation dialog box. The IP address of the interface 8 is written into the IP Addr field, and a MPLS label, which will be assigned to the IP traffic by the NE 1 to convert this to MPLS traffic, is written into the Label field. No further information relating to the egress interface 8 is required. The hop creation dialog box comprises an OK button. When the user has written into all the editable fields appropriate to the hop being created, the OK button is selected which commits the changes to the editable fields to the created hop, dismisses the hop creation dialog box, and returns the user to the RO creation dialog box. The created hop is displayed in the first row of the hop listing table in the RO creation dialog box. The row comprises one or more columns, which display the contents of the editable fields written into to create the hop. Thus, only columns appropriate to the hop are displayed.

To create the second hop of the RO, the user again selects the add hop button of the hop listing table of the RO creation dialog box. The add hop button again brings up a hop creation dialog box, as shown in FIG. 3. The route of the second hop starts at the ingress interface 10 of the NE 2, goes through the NE 2 to an egress interface 11 thereof, and along a link 12 to an ingress interface 13 of the NE 3, i.e. this hop starts at the NE 2 and goes to the NE 3. To define the route of this hop, it is necessary to provide information relating to the ingress interface 10 and the egress interface 11 of the NE 2. It is not necessary to provide information relating to the ingress interface 13 of the NE 3. This is because, as before, once it is identified that the hop route should pass through egress interface 11 of the NE 2, this determines the remainder of the route as this interface is connected to link 12 which in turn is connected to ingress interface 13 of the NE 3. To create the second hop the user again writes the name of the RO comprising the hop into the Route Name field, the position of the hop within the RO into the Hop Index field, a user-defined name of the NE 2, where the route defined by the hop starts, into the Orig field, a user-defined name of the NE 3, where the route defined by the hop goes to, into the Term field, the type of the route defined by the hop into the Protocol field, the general position of the hop within the RO into the Hop Type field, and the protocol(s) used by the hop into the Cross Connect field, of the hop creation dialog box. The user then writes the required information relating to the ingress interface 10 of the NE 2 into the ‘Ingress Interface’ fields of the hop creation dialog box. The route defined by the second hop will receive MPLS traffic and output MPLS traffic, for passage along the route of the hop. Therefore, for this hop, a user-defined name of the ingress interface 10 is written into the I/F field, and a MPLS label is written into the Label field. This MPLS label must equal the MPLS label of the egress interface 8 of the NE 1, for transmission of traffic from the NE 1 to the NE 2. No other information relating to the ingress interface 10 of the NE 2 is required. The user then writes the required information relating to the egress interface 11 of the NE 2 into the ‘Egress Interface’ fields of the hop creation dialog box. The user-defined name of the interface 11 is written into the I/F field, and a MPLS label of 0 is written into the Label field. This MPLS label value tells the NE 3 to remove any MPLS labelling from traffic received by it. No further information relating to the egress interface 11 of the NE 2 is required.

The user then selects the OK button, which commits the changes to the editable fields to the created hop, dismisses the hop creation dialog box, and returns the user to the RO creation dialog box. The created hop is displayed in the second row of the hop listing table in the RO creation dialog box. The columns of the row display the contents of the editable fields written into to create the hop.

On returning for the last time to the RO creation dialog box, the user presses the OK button in this box, which commits the RO and hop details to the created RO, and stores the RO in a database linked to the RO computer program product.

1.-21. (canceled)

22: In a telecommunications network, a route object (RO) computer program product, comprising: means for creating the RO which presents a user with editable fields relating to more than one type of the RO, and allows the user to specify contents of at least one of the fields to create any one of the types of the RO.

23: The RO computer program product according to claim 22, in which the RO presents the at least one editable field relating to a type of route defined by the RO.

24: The RO computer program product according to claim 22, in which the RO presents at least one editable field relating to at least one network element (NE) of a route through the telecommunications network defined by the RO.

25: The RO computer program product according to claim 22, in which each type of RO comprises at least one hop, and the RO computer program product presents at least one editable field relating to the at least one hop of the RO.

26: The RO computer program product according to claim 22, in which, when the user specifies the contents of the at least one editable field, at least one of the specified field and the specified contents is used by the RO computer program product to determine which subsequent editable field is presented to the user.

27: The RO computer program product according to claim 22, in which, when the user specifies the contents of the at least one editable field, at least one of the specified field and the specified contents is used by the RO computer program product to determine at least one default setting of at least one subsequent editable field presented to the user.

28: The RO computer program product according to claim 22, and comprising means for modifying at least one RO.

29: The RO computer program product according to claim 22, and comprising means for copying at least one RO.

30: The RO computer program product according to claim 22, and comprising means for storing at least one RO in a storage facility.

31: The RO computer program product according to claim 22, and comprising means for deleting at least one RO.

32: The RO computer program product according to claim 22, and comprising means for discovering at least one RO.

33: The RO computer program product according to claim 22, and comprising means for discovering changes in the telecommunications network.

34: The RO computer program product according to claim 22, and comprising means for interfacing with the user.

35: The RO computer program product according to claim 34, in which the means for interfacing presents a same interface to the user regardless of the type of the RO to be created.

36: The RO computer program product according to claim 34, in which the means for interfacing comprises a graphical user interface (GUI) which presents at least one window to the user, to allow the user to create the RO.

37: The RO computer program product according to claim 36, in which the GUI presents a network element (NE) listing window to the user which comprises a NE context menu having a create RO menu item which brings up a window comprising a RO creation dialog box, which comprises at least one editable field relating to at least one type of RO, and the user specifies the contents of at least one of the fields to create any one of the types of RO.

38: The RO computer program product according to claim 36, in which the RO being created comprises at least one hop, and the at least one hop is added to the RO using a window comprising a hop creation dialog box, which comprises at least one editable field relating to at least one type of hop, and the user specifies the contents of at least one of the fields to create any one of the types of hop.

39: The RO computer program product according to claim 36, in which the RO being created comprises a group RO, and the GUI presents a network element (NE) listing window to the user which comprises a NE context menu having a create group RO menu item which brings up a window comprising a group RO creation dialog box, which comprises at least one editable field relating to at least one type of group RO, and the user specifies the contents of at least one of the fields to create any one of the types of group RO.

40: A method of creating a route object (RO), comprising the steps of: running a RO computer program product which creates the RO which presents editable fields relating to more than one type of the RO; and specifying contents of at least one of the fields to create any one of the types of the RO.

41: A network management system (NMS), comprising: a route object (RO) computer program product including means for creating the RO which presents a user with editable fields relating to more than one type of the RO, and allows the user to specify contents of at least one of the fields to create any one of the types of the RO.

42: A method of setting up a connection of a telecommunications network, comprising the steps of: using a route object (RO) created using a RO computer program product operative for creating the RO, and presenting a user with editable fields relating to more than one type of the RO, and allowing the user to specify contents of at least one of the fields to create any one of the types of the RO.
